(19) United States
(12) Patent Application Publication
(10) Pub. No.: US 2025/0191488 A1
(43) Pub. Date: Jun. 12, 2025

(54) APPARATUS AND METHOD FOR SUPPORTING LEARNING OF PROBLEM

(71) Applicant: WOONGJIN THINKBIG CO., LTD., Paju-si (KR)

(72) Inventors: Samrak CHOI, Paju-si (KR); Haejin KIM, Paju-si (KR)

(73) Assignee: WOONGJIN THINKBIG CO., LTD., Paju-si (KR)

(21) Appl. No.: 18/972,676

(22) Filed: Dec. 6, 2024

(30) Foreign Application Priority Data
Dec. 6, 2023 (KR) 10-2023-0175272

(51) Int. Cl. G09B 7/02; G06F 3/04883

(52) U.S. Cl. CPC G09B 7/02; G06F 3/04883

(57) ABSTRACT

The present disclosure discloses a device and method for supporting question learning of a learner by detecting a leaner's answer through handwriting recognition, inputting the learner's answer into an artificial intelligence model to detect an error location and an error cause, and displaying a location and error cause that become the cause of an incorrect answer.

### TECHNICAL FIELD

The present disclosure relates to a technology for providing learning questions and providing a scoring result for a learner's solution.

### BACKGROUND ART

In general, when a learner solves learning questions, conventional question learning support devices (or applications) compares values of answers input by the learner with correct answers for the provided learning questions and scores the learner's solution. That is, when the learner's answer is the same as a correct answer to a question, the question learning support device scores the answer as a correct answer and otherwise, scores the answer as an incorrect answer.

The conventional question learning support devices provide the cause of errors to the learner upon the occurrence of an incorrect answer when an incorrect answer and cause of errors defined in advance for the learning question are present.

However, when the errors of cause for the learning question is not defined in advance, the conventional question learning support devices have difficulty in specifically identifying the cause of errors of the learner, and thus fails to explain at which point the incorrect answer occurs and provides the learner with only the extent to which the incorrect answer occurs.

From the perspective of teaching and learning, when considering that learning is promoted through the correction of errors (i.e., the cause of errors), since the conventional question learning support devices do not provide feedback on the cause of the learner's incorrect answer and thus the learning can be considered as missing the opportunity to promote learning, it is difficult to determine that appropriate learning intervention occurs.

The matters described above in the background art are intended to help understanding of the background of the disclosure and may include matters not related to the known related art.

### RELATED ART DOCUMENTS

### Patent Documents

[Patent Document 1] Korean Registration Patent No. 10-1671693.

[Patent Document 1] Korean Registration Patent No. 10-20200135418.

### SUMMARY OF INVENTION

### Technical Problem

The present disclosure has been proposed in consideration of the above point and is directed to providing a question learning support device and method for indicating a location of the cause of an incorrect answer during the process of solving a learning question and indicating the cause of the incorrect answer.

### Solution to Problem

To achieve the above objects, a question learning support device according to an embodiment of the present disclosure includes a control module configured to output a learning question output request message in response to a question learning start request, output a learner answer detection request message in response to a learning question output completion message, which is a response to the learning question output request message, output a learning question scoring request message in response to a learner answer detection completion message, which is a response to the learner answer detection request message, and output an evaluation output request message when it is determined that a learner's answer is incorrect based on a scoring completion message, which is a response to the learning question scoring request message, a question information detection module configured to detect learning question information in response to the learning question output request message of the control module and output a question output request message including the learning question information, a learning question output module configured to generate a learning question output screen including the learning question information in response to the question output request message of the question information detection module and transmit a learning question output completion message after outputting the learning question output screen, a handwriting area detection module configured to detect a part of the learning question output screen as a learner answer area in response to a learner answer detection request message of the control module and output a handwriting area detection completion message including the learner answer area, a handwriting recognition module configured to detect a learner's answer by performing handwriting recognition on the learner answer area in response to the handwriting area detection completion message of the handwriting area detection module and transmit a learner answer detection completion message including the learner's answer, a scoring module configured to generate a scoring prompt including the learner's answer in response to the learning question scoring request message of the control module to transmit the scoring prompt to an artificial intelligence model and transmit a scoring completion message including a result of the scoring to the control module when receiving the result of the scoring, which is a response to the scoring prompt, from the artificial intelligence model, and a scoring result output module configured to detect a part of the learner answer area as an error occurrence area based on the result of the scoring in response to the evaluation output request message of the control module and overlap and output the occurrence of an error in the error occurrence area.

The learning question output module may generate a learning question output screen including a learning question display area and a question solution area, the learning question display area may be an area, in which a learning question detected from the learning question information, of the learning question output screen, and the question solution area may be an area in which a question solution process of a learner to the learning question is input through handwriting.

The handwriting area detection module may detect an area, in which a solution process is handwritten, of a question solution area of the learning question output screen as the learner answer area. The handwriting area detection module may detect the learner answer area, which includes vertex coordinates of an area in which a solution process is handwritten, of a question solution area of the learning question output screen.

The handwriting recognition module may detect a leaner's answer composed of text and detects a learner's answer composed of LaTex code when a learning question is a math question.

The scoring module may set a prompt including a code area into which the learner's answer is inserted and generate a scoring prompt that inserts the learner's answer detected from the handwriting recognition module into the code area.

The scoring module may receive the result of the scoring including an error location and an error cause from the artificial intelligence model and transmit the scoring completion message including the result of the scoring to the control module.

The control module may determine that the learner's answer is incorrect when the result of the scoring detected from the scoring completion message includes an error location and transmit an evaluation output request message including the error location to the scoring result output module, and the scoring result output module may detect the error location from the evaluation output request message of the control module, detect an area, which corresponds to the error location, of the learner answer area of the learning question output screen as an error occurrence area and display an error occurrence symbol in the error occurrence area.

The control module may determine that the learner's answer is incorrect when the result of the scoring detected from the scoring completion message includes an error location and an error cause and transmit an evaluation output request message including the error location and the error cause to the scoring result output module, and the scoring result output module may detect the error location and the error cause from the evaluation output request message of the control module, detect an area, which corresponds to the error location, of the learner answer area of the learning question output screen as an error occurrence area, display an error occurrence symbol in the error occurrence area, and display the error cause near the error occurrence area.

The control module may determine that the learner's answer is correct when the result of the scoring detected from the scoring completion message does not include an error location and an error cause and transmit a positive feedback output request message to the scoring result output module, and the scoring result output module may overlap and output positive feedback on the learning question output screen in response to the positive feedback output request message of the control module.

To achieve the above objects, a question learning support method performed by a question learning support device according to an embodiment of the present disclosure includes detecting learning question information in response to a question learning start request, outputting a learning question output screen including the learning question information detected in the detecting of the learning question information, detecting a part of the learning question output screen as a learner answer area, detecting a leaner's answer through handwriting recognition on a learner answer area detected in the detecting of the leaner answer area, generating a scoring prompt including the learner's answer and outputting the scoring prompt to an artificial intelligence model, and outputting a result of scoring of the artificial intelligence model, which is a response to the scoring prompt.

The outputting of the learning question output screen may include outputting a learning question output screen including a learning question display area in which the learning question information is displayed and a question solution area in which a question solution process of a learner to the learning question is handwritten.

The detecting of the learner's answer may include detecting an area, in which a solution process is handwritten, of a question solution area of the learning question output screen as the learner answer area.

The detecting of the learner's answer may include detecting the learner answer area including vertex coordinates of an area, in which a solution process is handwritten, of a question solution area of the learning question output screen.

The detecting of the learner's answer may include detecting a leaner's answer composed of text and detecting a learner's answer composed of LaTex code when a learning question is a math question.

The outputting of the scoring prompt may include setting a prompt including a code area into which the learner's answer is inserted, and outputting a scoring prompt that inserts the learner's answer detected in the detecting of the learning's answer into the code area.

The outputting of the result of the scoring may include detecting a part of the learner answer area as an error occurrence area and overlapping and outputting occurrence of an error in the error occurrence area.

The outputting of the result of the scoring may include determining that the learner's answer is correct when the result of the scoring of the artificial intelligence model does not include an error location and an error cause, and overlapping and outputting positive feedback on the learning question output screen.

The outputting of the result of the scoring may include determining that the learner's answer is incorrect when the result of the scoring received from the artificial intelligence model includes an error location, detecting an area, which corresponds to the error location, of the learner answer area of the learning question output screen as an error occurrence area, and displaying an error occurrence symbol in the error occurrence area.

The outputting of the result of the scoring may include determining that the learner's answer is incorrect when the result of the scoring received from the artificial intelligence model includes an error location and an error cause, detecting an area, which corresponds to the error location, of the learner answer area of the learning question output screen as an error occurrence area, displaying an error occurrence symbol in the error occurrence area, and displaying the error cause near the error occurrence area.

### Advantageous Effects of Invention

The question learning support device and method according to the present disclosure, it is possible to allow the learner to easily check the error location by detecting the learner's answer through handwriting recognition, inputting the learner's answer into the artificial intelligence model, and detecting and indicating the error location that is the cause of the incorrect answer.

In addition, according to the question learning support device and method, it is possible to allow the learner to easily check the cause of the incorrect answer by detecting the learner's answer through handwriting recognition, inputting the learner's answer into the artificial intelligence model, and detecting and indicating the error cause that is the cause of the incorrect answer.

In addition, according to the question learning support device and method, it is possible to provide the service that induces the learner to actively proceed with learning by indicating the error location and the error cause so that the learner can easily check the cause of the incorrect answer.

In addition, according to the question learning support device, it is possible to induce the learner to proceed with additional learning for the question of the incorrect answer by outputting a reminder alarm when no additional activity for the incorrect answer is detected.

### BRIEF DESCRIPTION OF DRAWINGS

FIG. 1 is a view for describing a question learning support device according to an embodiment of the present disclosure.

FIG. 2 is a block diagram for describing a configuration of the question learning support device according to the embodiment of the present disclosure.

FIG. 3 is a view for describing a learning question output module of FIG. 2.

FIGS. 4 to 6 are views for describing a handwriting area detection module of FIG. 2.

FIGS. 7 and 8 are views for describing a scoring module of FIG. 2.

FIGS. 9 to 11 are views for describing a scoring result output module of FIG. 2.

FIG. 12 is a block diagram for describing a modified example of the question learning support device according to the embodiment of the present disclosure.

FIG. 13 is a flowchart for describing the question learning support method according to the embodiment of the present disclosure.

FIG. 14 is a flowchart for describing a learning question information detecting operation S100 of FIG. 13.

FIG. 15 is a flowchart for describing a scoring result output operation S800 of FIG. 13.

### DESCRIPTION OF EMBODIMENTS

Hereinafter, exemplary embodiments according to the present disclosure will be described in detail with reference to the accompanying drawings.

The embodiments are provided to more completely describe the present disclosure to those skilled in the art, and the following embodiments may be modified in various different forms, and the scope of the present disclosure is limited to the following embodiments. Rather, the embodiments are provided to make the disclosure more faithful and complete and fully convey the spirit of the present disclosure.

Terms used herein are intended to describe specific embodiments and are not intended to limit the present disclosure. In addition, in the present specification, singular forms may include plural forms unless the context clearly indicates otherwise.

In the present specification, it should be understood that the term “comprise,” “including,” “have,” etc. is intended to specify that a feature, a number, a step, an operation, a component, a part, or a combination thereof of the invention is present, but do not preclude the possibility of the presence or addition of one or more other features, numbers, steps, operations, components, parts, or a combination thereof.

Those skilled in the art will appreciate that various exemplary blocks, devices, or operations described in connection with components disclosed herein may be implemented as electronic hardware, computer software, or a combination thereof. These blocks, devices, or operations may be implemented or performed using a processor, a digital signal processor (DSP), an application-specific integrated circuit (ASIC) or application-specific standard product (ASSP), a field-programmable gate array (FPGA) or other programmable logic device, an individual gate or transistor logic, individual hardware component, or any combination thereof designed to generate a configuration as disclosed herein. The processor may be implemented as a combination of computing devices, for example, a combination of a DSP and a microprocessor, a plurality of microprocessors, one or more microprocessors in connection with a DSP core, or any other component. The computer software or program may be present in a random access memory (RAM), a read-only memory (ROM), a nonvolatile RAM such as a flash RAM, an erasable programmable ROM (EPROM), an electrically erasable programmable ROM (EEPROM), a register, a hard disk, a removable disk, a CD-ROM, or any other form of storage medium known in the art and may include a machine-readable command executable by an array of logic elements, such as a processor or a DSP. An exemplary storage medium may be coupled to the processor, and the processor may read information from the storage medium and write information to the storage medium. Alternately, the storage medium may be integrated with the processor. The processor and the storage medium may be located in an ASIC. The ASIC may be located in a user terminal. Alternately, the processor and the storage medium may be present as individual components in the user terminal.

The drawings are only intended to help understanding of the spirit of the present disclosure and should not be construed as limiting the scope of the present disclosure by the drawings. In addition, in the drawings, a relative thickness and length, or a relative size may be exaggerated for convenience and clarity of description.

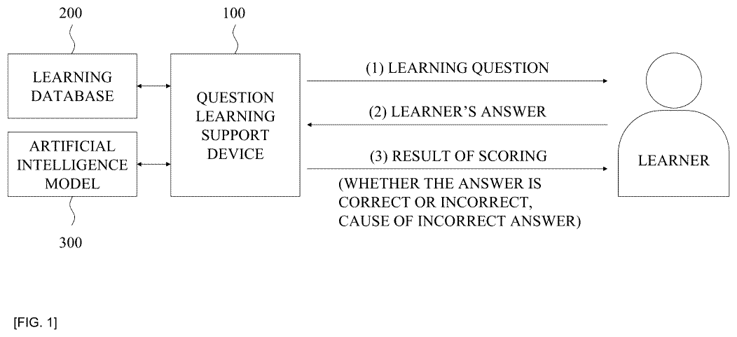

Referring to FIG. 1, a question learning support device 100 according to an embodiment of the present disclosure is configured to be linked with a learning database 200 and an artificial intelligence model 300.

The question learning support device 100 outputs learning questions stored in the learning database 200 to induce a learner's solution, receives the learner's answers to the learning questions to request an artificial intelligence model 300 to score the learner's answers, and outputs the scoring result of the artificial intelligence model 300.

To this end, the question learning support device 100 is configured as a digital device that provides learning questions to the learner using a question learning service and generates and outputs the scoring result. The question learning support device 100 may provide learning questions to the learner and may be configured as a mobile device such as a mobile phone or tablet PC as well as a desktop or notebook computer.

The question learning support device 100 may provide services through a web and app of a digital device and may be configured as a system including a question learning support server and a learner terminal.

The question learning support device 100 may include the learning database 200 or may be configured to communicate with a learning database 200 server. Here, the learning database 200 is a storage device for storing learning question information, learner's learning history information, etc.

The learning database 200 may include a learning question information table. The learning question information table is a table of a database in which learning question information such as subjects, grades, concepts (units), texts, formulas, answers, etc. for learning questions provided to learners are stored. The question learning support device 100 extracts learning question information from the learning database 200 and provides learning questions to the learner. In this case, the learning question information stored in the learning database 200 may have each unique question identifier, and the unique question identifier may be used as a distinguishing value from other questions.

The learning history table is a table in which members' response histories to problems provided by a learning application are stored and is a table in which questions provided to the members, the time the questions are provided, the content entered by the members for the questions, correct or incorrect answer information for the questions, the causes of the incorrect answers, etc. are stored. The members' problem-solving histories may be computerized and stored and may be used in the future when the members' strengths and weaknesses are analyzed or difficulty levels for the learning concept are calculated.

The question learning support device 100 recognizes the learner's handwriting and receives the learner's answers. The question learning support device 100 receives the learner's answers including a solution process for the learning questions.

To this end, the question learning support device 100 detects a learner answer area, which is an area in which the learner writes to solve the learning questions. As an example, the question learning support device 100 detects coordinates of the area in which the learner writes to solve the learning questions on a screen as the learner answer area.

The question learning support device 100 receives the learner's answers through handwriting recognition for the learner answer area. Here, the handwriting recognition is a technology for tracking an input value when the learner inputs handwriting into the question learning support device 100 and reading the corresponding input value as a letter, number, or symbol. The question learning support device 100 may convert the information read through the handwriting recognition into a specific code according to a domain in which learning is performed and store the specific code. For example, when the learning question is a math question and the value read from the learner's handwriting has a mathematical meaning, the question learning support device 100 receives the learner's answers converted into LaTex codes.

That is, when learning questions are output and then the leaner starts to solve the learning questions, the question learning support device 100 detects the learner answer area, which is an area in which the learner enters the solution, through handwriting recognition and detects the learner's answers through the handwriting recognition of the learner answer area.

The question learning support device 100 generates a learner answer prompt including the learner's answers for scoring. The question learning support device 100 generates the scoring result including whether the answer is correct or incorrect through the learner answer prompt and an artificial intelligence (AI) model. Here, the artificial intelligence model 300 is artificial intelligence that may create new content such as language, images, videos, music, etc. and, for example, may be the artificial intelligence model 300 that may conduct a conversation about the user's request using a large language model (LLM) technology such as a ChatGPT.

In the case of an incorrect answer, the question learning support device 100 generates the scoring result that further includes the location (or area) of the error, which is a location of a portion, in which the learner made a mistake in the solution process, of the learner answer area, and the error cause.

The question learning support device 100 outputs the scoring result, which is a response to whether the answer is correct or incorrect. The question learning support device 100 outputs positive feedback when the learner's answer is correct.

The question learning support device 100 outputs an incorrect answer alarm including the error location and the error cause when the learner's answer is incorrect. In order for the learner to easily recognize the error location, the question learning support device 100 outputs an incorrect answer alarm at a location, which corresponds to the error location, of the learner answer area.

The question learning support device 100 outputs the error cause together with the incorrect answer alarm. In this case, the question learning support device 100 may output the error cause in an area that does not overlap the learner answer area so as not to interfere with the learner's relearning of the question.

When not detecting the leaner's additional activity after outputting the incorrect answer alarm, the question learning support device 100 may output a reminder alarm to induce the learner's additional learning. The question learning support device 100 outputs the reminder alarm such as vibrations, notification sound, blinking, etc. when not detecting the learner's additional activity (i.e., solving activity) at the error location.

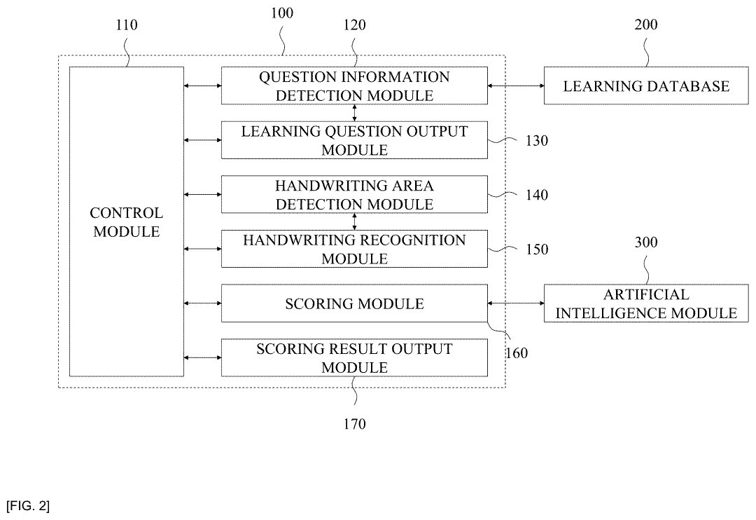

Referring to FIG. 2, the question learning support device 100 includes a control module 110, a question information detection module 120, a learning question output module 130, a handwriting area detection module 140, a handwriting recognition module 150, a scoring module 160, and a scoring result output module 170. Here, although FIG. 2 illustrates the use of the external artificial intelligence model 300 to easily describe the question learning support device 100 according to the embodiment of the present disclosure, the present disclosure is not limited thereto, and the question learning support device 100 may be configured to communicate with the external artificial intelligence model 300.

The control module 110 generates a learning question output request message in response to the learner's question learning start request. The control module 110 generates the learning question output request message including a learner identifier. The control module 110 transmits the learning question output request message to the question information detection module 120 and the learning question output module 130.

The control module 110 generates a learner answer detection request message in response to a learning question output completion message of the learning question output module 130. The control module 110 transmits the learner answer detection request message to the handwriting area detection module 140 and the handwriting recognition module 150.

The control module 110 generates a learning question scoring request message in response to the learner answer detection completion message of the handwriting recognition module 150. The control module 110 detects the learner's answers from the learner answer detection completion message. The control module 110 generates a scoring request message including the learning questions and the learner's answers and transmits the scoring request message to the scoring module 160.

The control module 110 generates an evaluation output request message in response to a scoring completion message of the scoring module 160. The control module 110 detects the scoring result from the scoring completion message.

When the scoring result does not include the error location and the error cause, the control module 110 determines that the learner's answer is correct. When determining that the learner's answer is correct, the control module 110 generates a positive feedback output request message and transmits the positive feedback output request message to the scoring result output module 170.

When the scoring result includes the error location and the error cause, the control module 110 determines that the learner's answer is incorrect. When determining that the learner's answer is incorrect, the control module 110 generates the evaluation output request message including the scoring result and transmits evaluation output request message to the scoring result output module 170.

The question information detection module 120 detects learning question information from the learning database 200 in response to the learning question output request message of the control module 110.

The question information detection module 120 detects a learner identifier from the learning question output request message. The question information detection module 120 generates a question detection query including the learner identifier. The question information detection module 120 transmits the question detection query to the learning database 200.

The learning database 200 detects learning question information in response to the question detection query of the question information detection module 120. The learning database 200 generates a response message including the learning question information and transmits the response message to the question information detection module 120.

The question information detection module 120 generates the learning question output request message in response to the response message of the learning database 200 and transmits the learning question output request message to the learning question output module 130. The question information detection module 120 detects learning question information from the response message. The question information detection module 120 generates the question output request message including the learning question information. The question information detection module 120 transmits the question output request message to the learning question output module 130.

The learning question output module 130 prepares the output of a learning question output screen in response to the learning question output request message of the control module 110. The learning question output module 130 outputs the learning question output screen in response to the learning question output request message of the question information detection module 120 received after receiving the learning question output request message.

The learning question output module 130 detects the learning question information from the learning question output request message. The learning question output module 130 generates the learning question output screen using the learning question information.

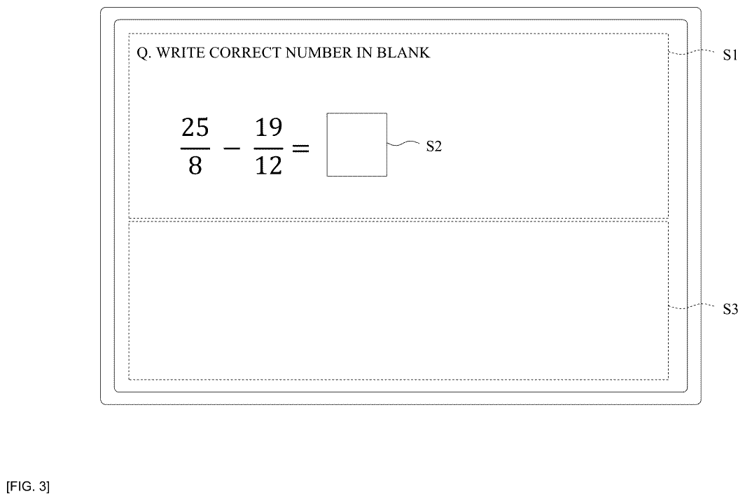

For example, referring to FIG. 3, the learning question output module 130 generates the learning question output screen including a learning question display area S1 in which learning questions are displayed, a learner answer input area S2 in which the learner writes his/her answers to learning questions, and a question solution area S3 in which the learner writes the solution process for solving the learning questions.

The learning question output module 130 outputs the learning question output screen. The learning question output module 130 generates the learning question output completion message after outputting the learning question output screen. The learning question output module 130 transmits the learning question output completion message to the control module 110.

The handwriting area detection module 140 detects the learner answer area on the screen in which the learning question output completion message is output in response to the learner answer detection request message of the control module 110. The handwriting recognition module 150 detects the area in which the learner writes the learner's answers to solve the learning question as the learner answer area.

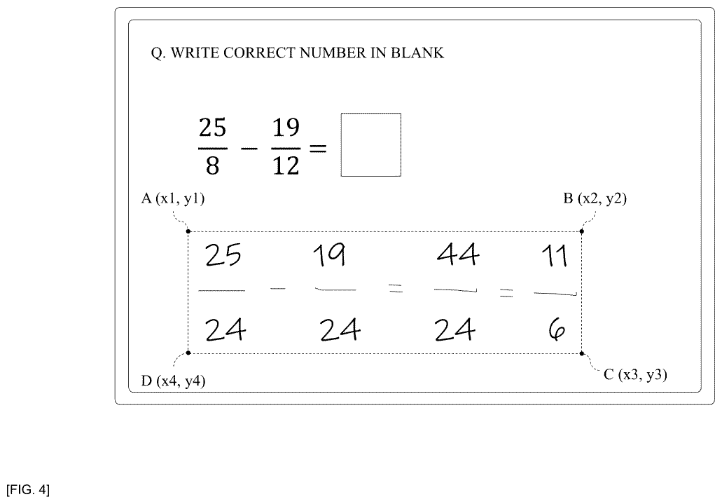

For example, referring to FIG. 4, the handwriting area detection module 140 displays the learning question output screen and then detects a quadrangular learner answer area including the area in which the learner writes the solution process to solve the learning questions. In this case, the handwriting area detection module 140 detects the learner answer area including coordinates (x1, y1), (x2, y2), (x3, y3), and (x4, y4) of corners A, B, C, and D of the quadrangular area including the area in which the learner writes the solution process as an example.

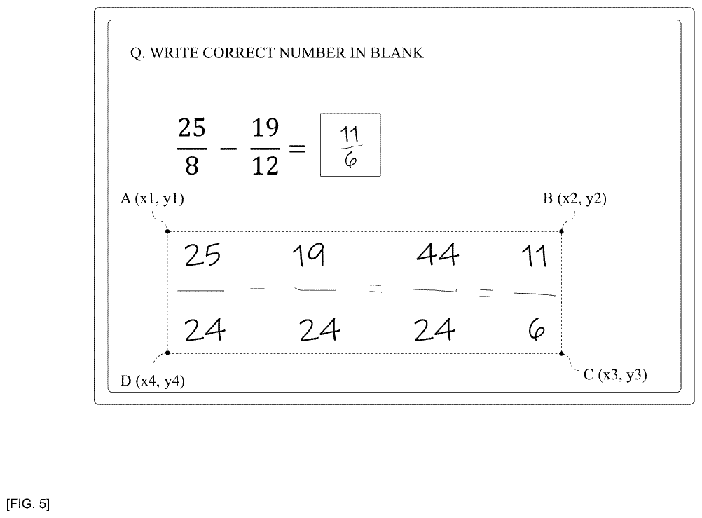

Referring to FIG. 5, when the learner inputs the learner's answers into the learner answer input area S2, the handwriting area detection module 140 may detect a learner answer area that further includes the learner answer input area S2. In this case, the handwriting area detection module 140 detects a learner answer area including coordinates of the corners A, B, C, and D of the quadrangular area including the area in which the learner writes the solution process and coordinates of the four corners of the learner answer input area S2 as an example.

The handwriting area detection module 140 generates the handwriting area detection completion message including the detected learner answer area. The handwriting area detection module 140 transmits the handwriting area detection completion message to the handwriting recognition module 150.

The handwriting recognition module 150 prepares handwriting recognition for the learning question output screen in response to the learner answer detection request message of the control module 110. The handwriting recognition module 150 performs handwriting recognition for the learner answer area of the learning question output screen in response to the handwriting area detection completion message of the handwriting recognition module 150 received after receiving the learner answer detection request message.

The handwriting recognition module 150 detects the learner answer area from the handwriting area detection completion message. The handwriting recognition module 150 performs handwriting recognition for the learner answer area of the learning question output screen. The handwriting recognition module 150 detects the learner's answers composed of text through the handwriting recognition.

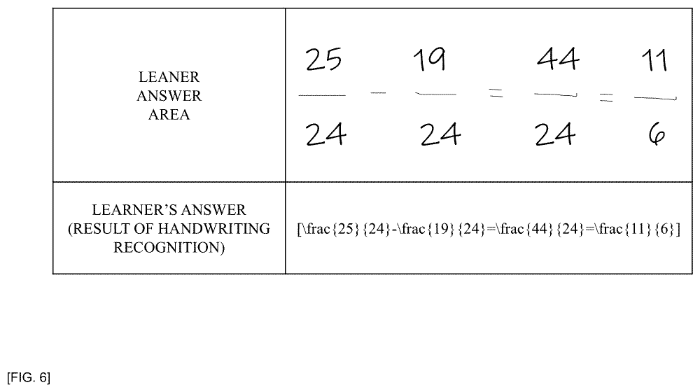

Referring to FIG. 6, the handwriting recognition module 150 detects the learner's answers composed of LaTex codes through the handwriting recognition for the learner answer area when the learning question is a math question as an example.

The handwriting recognition module 150 generates the learner answer detection completion message including the learner's answers. The handwriting recognition module 150 transmits the learner answer detection completion message to the control module 110.

The scoring module 160 generates a scoring prompt including the learning questions and the learner's answers in response to the scoring request message of the control module 110. The scoring module 160 transmits the scoring prompt to the artificial intelligence model 300.

The scoring module 160 detects the learning questions and the learner answers from the scoring request message. The scoring module 160 presets a scoring prompt including a first code area in which the learning questions are inserted and a second code area in which the learner's answers are inserted. The scoring module 160 inserts the learning questions into the first code area of the preset prompt for scoring the learner's answers of the artificial intelligence model 300 and inserts the learner's answers into the second code area to generate the scoring prompt.

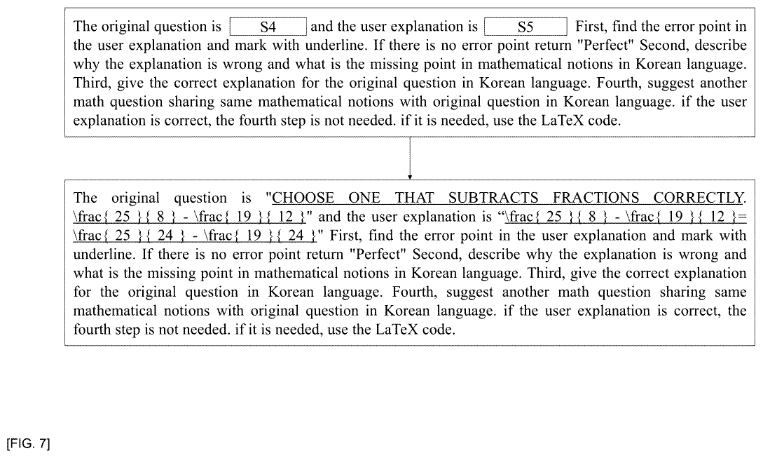

Referring to FIG. 7, the scoring module 160 predefines a math question scoring prompt including a first code area S4 into which the LaTex codes of the learning questions are input and a second code area S5 into which the LaTex codes of the learner's answers are input. The scoring module 160 detects the learning questions and the learner's answers composed of LaTex codes from the scoring request message of the learning question control module 110. The scoring module 160 inputs the LaTex codes of the learning questions into the first code area of the math question scoring prompt and inputs the LaTex codes of the learner's answers into the second code area of the math question scoring prompt to generate the math question scoring prompt.

The scoring module 160 transmits the generated scoring prompt to the artificial intelligence model 300.

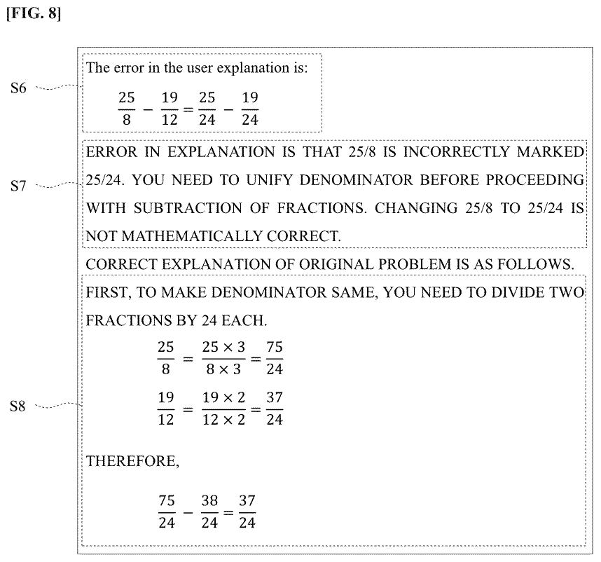

Referring to FIG. 8, the artificial intelligence model 300 scores the learner's answers in response to the scoring prompt of the scoring module 160 and outputs the scoring result including an error location S6, an error cause S7, and a correct solution formula S8.

After transmitting the scoring prompt, the scoring module 160 receives the scoring result output from the artificial intelligence model 300. The scoring module 160 generates the scoring completion message including the scoring result and transmits the scoring completion message to the control module 110.

The scoring result output module 170 overlaps and outputs the positive feedback on the learning question output screen in response to the positive feedback output request message of the control module 110. Here, the positive feedback is, for example, a learner compliment message for the correct answer, a correct answer message, etc.

The scoring result output module 170 outputs the scoring result for the learner's answers in response to the evaluation output request message of the control module 110. The scoring result output module 170 detects the scoring result from the evaluation output request message. The scoring result output module 170 outputs the scoring result to overlaps the learner answer area of the learning question output screen.

The scoring result output module 170 detects the error location and the error cause from the scoring result. The scoring result output module 170 detects an area, which corresponds to the error location, of the learner answer area of the learning question output screen as an error occurrence area. The scoring result output module 170 displays the occurrence of the error by underlining or displaying a box in the error occurrence area. The scoring result output module 170 displays the error cause near the error occurrence area.

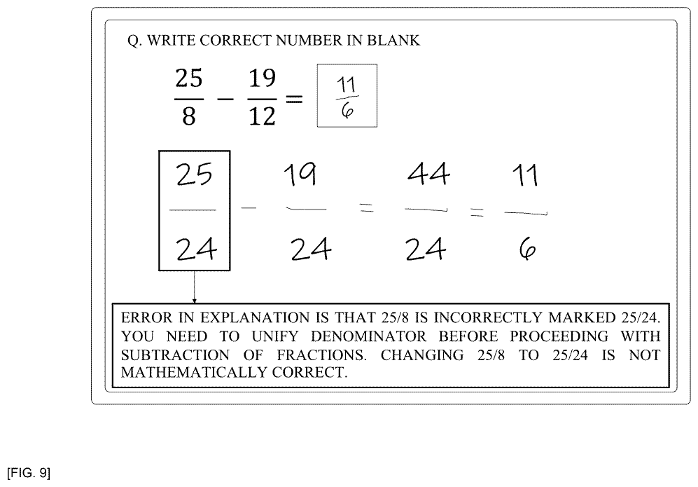

Referring to FIG. 9, the scoring result output module 170 displays the error occurrence area that is an area, which is detected as the error location by the artificial intelligence model 300, of the learner answer area of the learning question output screen using a box and displays the error cause detected by the artificial intelligence model 300 on the lower end of the error occurrence area.

The scoring result output module 170 may further display a correct solution formula. That is, the scoring result output module 170 further detects the correct solution formula from the scoring result. The scoring result output module 170 displays a solution formula symbol in the error occurrence area. The scoring result output module 170 displays the correct solution formula when the learner selects the solution formula symbol.

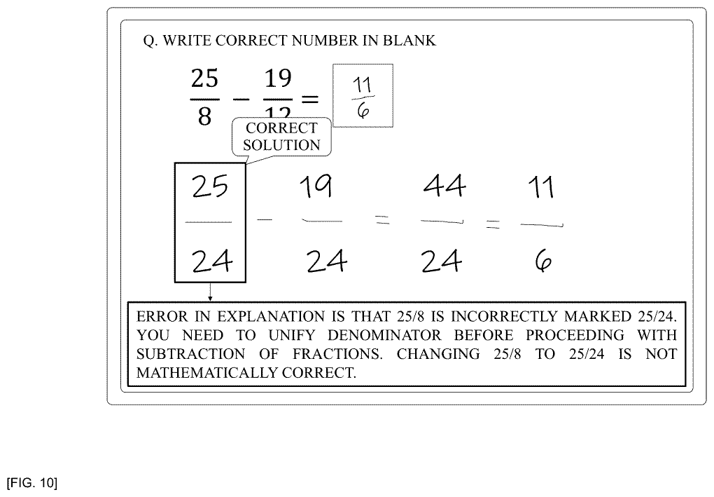

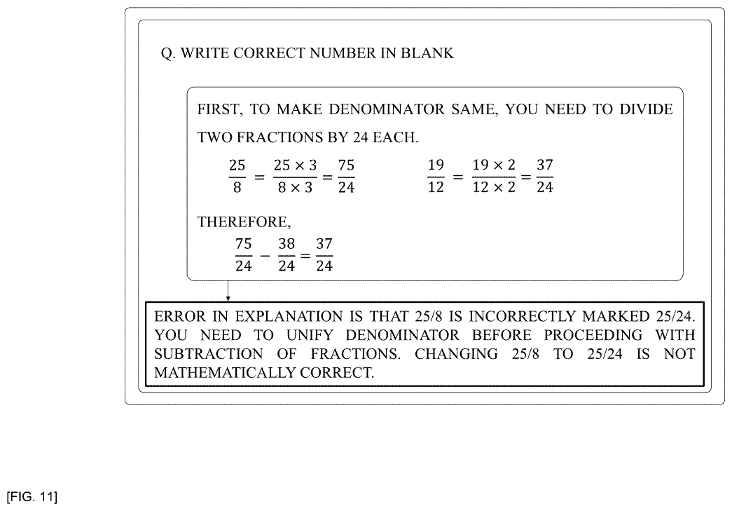

Referring to FIGS. 10 and 11, the scoring result output module 170 displays a speech bubble-shaped solution formula symbol in the error occurrence area of the learner answer area of the learning question output screen. When the learner selects the solution formula symbol, the scoring result output module 170 outputs a display window that displays the correct solution formula to overlap the learning question output screen.

The question learning support device 100 according to the embodiment of the present disclosure may detect the learner's additional activity after the output of the scoring result of the scoring result output module 170 is completed and output an alarm for inducing the leaner's additional activity when there is no additional activity.

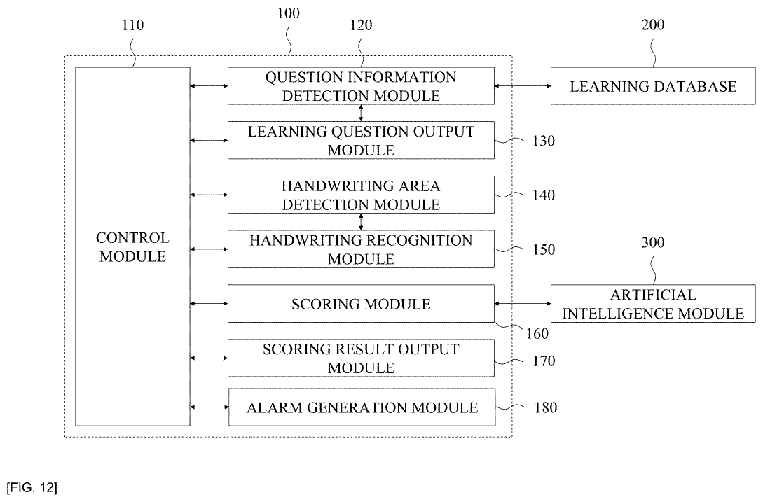

To this end, referring to FIG. 12, the question learning support device 100 further includes the alarm generation module 180.

The scoring result output module 170 generates the scoring result output completion message after completing the output of the scoring result and transmits the scoring result output completion message to the control module 110.

The control module 110 detects whether the learner conducts an additional activity in response to the scoring result output completion message of the scoring result output module 170. Here, the additional activity is, for example, the learner's answer correction through the learning question output screen.

The control module 110 controls the handwriting area detection module 140, the handwriting recognition module 150, the scoring module 160, and the scoring result output module 170 so that the scoring and evaluation output are repeated when detecting the learner's additional activity. The control module 110 generates an alarm output request message when no additional activity of the learner is detected and transmits the alarm output request message to the alarm generation module 180.

The alarm generation module 180 outputs a vibration alarm and/or a sound alarm in response to the alarm output request message of the control module 110 or outputs an alarm in which text or a symbol/color blinks on the learning question output screen.

Hereinafter, the question learning support method according to the embodiment of the present disclosure will be described with reference to the accompanying drawings as follows.

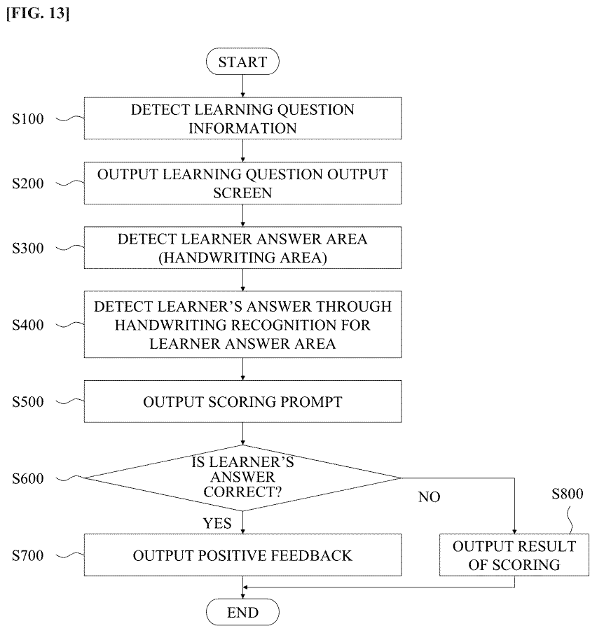

Referring to FIG. 13, the question learning support device 100 detects learning question information in response to the question learning start request of the learner (S100).

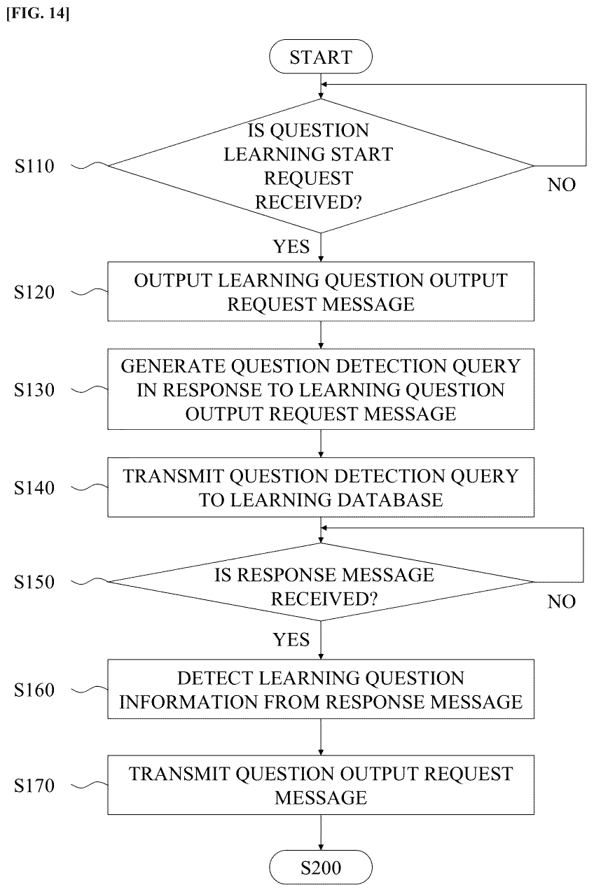

Referring to FIG. 14, when receiving the question learning start request of the learner (Yes in S110), the control module 110 outputs the learning question output request message (S120). In operation S120, the control module 110 generates the learning question output request message including the learner identifier and transmits the learning question output request message to the question information detection module 120 and the learning question output module 130.

The question information detection module 120 generates a question detection query in response to the learning question output request message of the control module 110 (S130). In operation S130, the question information detection module 120 generates the question detection query including the learner identifier detected from the learning question output request message.

The question information detection module 120 transmits the question detection query to the learning database 200 (S140).

The learning database 200 detects learning question information in response to the question detection query of the question information detection module 120. The learning database 200 generates a response message including the learning question information and transmits the response message to the question information detection module 120. When receiving a response message from the learning database 200 (Yes in S150), the question information detection module 120 detects learning question information from the response message (S160).

The question information detection module 120 generates the question output request message including the learning question information detected in operation S160 and transmits the question output request message to the learning question output module 130 (S170).

The question learning support device 100 outputs the learning question output screen including the learning question information detected in operation S100 (S200). The question learning support device 100 outputs a learning question output screen including the learning question display area S1 in which learning questions are displayed, the learner answer input area S2 in which the learner writes the learner's answers to the learning questions, and the question solution area S3 in which the learner writes a solution process for solving the learning questions.

The learner solves the learning questions on the learning question output screen output by the question learning support device 100. The learner solves the learning questions displayed in the learning question display area S1. The learner solves the learning questions using the learner answer input area S2 and the question solution area S3.

The question learning support device 100 detects the learner answer area that is an area, in which the learner's handwriting is input, of the learning question output screen output in operation S200 (S300).

In operation S300, the question learning support device 100 detects the learner answer area on the screen in which the learning question output completion message is output. The question learning support device 100 detects the area in which the learner writes the learner's answers to solve the learning questions as the learner answer area.

In operation S300, the question learning support device 100 may detect the learner answer area including the coordinates of the vertices of the quadrangular area including the area in which the learner writes the solution process.

In operation S300, the question learning support device 100 may detect the learner answer area further including the learner answer input area. In this case, the question learning support device 100 may detect the learner answer area including the vertex coordinates of the learner answer input area.

The question learning support device 100 performs handwriting recognition on the learner answer area detected in operation S300 and detects the learner's answers (S400).

In operation S400, the question learning support device 100 detects the learner's answer composed of text through the handwriting recognition on the learner answer area. In this case, when the learning question is a math question, the question learning support device 100 may detect the learner's answers composed of LaTex code through the handwriting recognition on the learner answer area.

The question learning support device 100 generates a scoring prompt based on the learner's answers detected in operation S400 and outputs the scoring prompt to the artificial intelligence model 300 (S500).

In operation S400, the question learning support device 100 presets the scoring prompt including the first code area in which the learning question is inserted and the second code area in which the learner's answers are inserted. The question learning support device 100 inserts learning questions into the first code area of the preset prompt for scoring the learner's answers of the artificial intelligence model 300, inserts the learner's answers detected in operation S400 into the second code area to generate the scoring prompt, and outputs (transmits) the scoring prompt to the artificial intelligence model 300.

For example, the question learning support device 100 predefines a math question scoring prompt including the first code area S4 in which the LaTex codes of the learning questions are input and the second code area S5 in which the LaTex codes of the learner's answers are input. The question learning support device 100 detects the learning questions and the learner's answers composed of the LaTex codes detected in operation S400. The question learning support device 100 inputs the LaTex codes of the learning questions into the first code area of the math question scoring prompt and inputs the LaTex codes of the learner's answers into the second code area of the math question scoring prompt to generate the math question scoring prompt.

The artificial intelligence model 300 scores the learner's answers in response to the scoring prompt of the question learning support device 100 and outputs the result of the scoring including the error location, the error cause, and the correct solution formula. The question learning support device 100 determines whether the learner's answer is correct or incorrect based on the result of the scoring of the artificial intelligence model 300. When the result of the scoring does not include the error location and the error cause, the question learning support device 100 determines that the learner's answer is correct, and when the result of the scoring includes the error location and the error cause, it is determined that the learner's answer is incorrect.

When it is determined that the learner's answer is correct as the result of the scoring (Yes in S600), the question learning support device 100 outputs positive feedback (S700).

In operation S700, the question learning support device 100 overlaps and outputs positive feedback on the learning question output screen. In this case, the question learning support device 100 may output positive feedback such as a learner compliment message and a correct answer message.

When it is determined that the learner's answer is incorrect as the result of the scoring, the question learning support device 100 outputs the result of the scoring (S800).

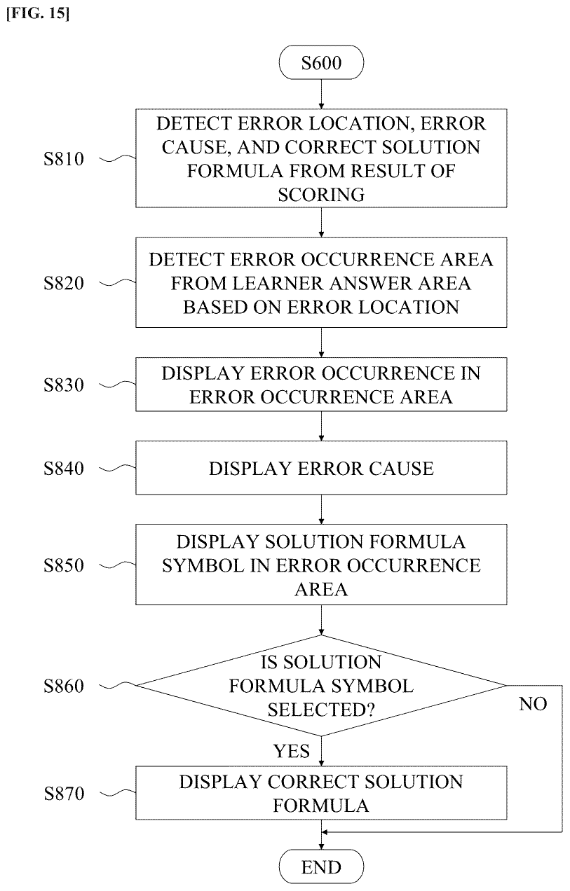

Referring to FIG. 15, the question learning support device 100 detects the error location, the error cause, and the correct solution formula from the result of the scoring of the artificial intelligence model 300 (S810).

The question learning support device 100 detects an area, which corresponds to the error location, of the learner answer area on the learning question output screen as an error occurrence area (S820).

The question learning support device 100 displays the occurrence of an error through underlining or displaying a box in the error occurrence area (S830). In operation S830, the question learning support device 100 may display the error occurrence area, which is an area detected as the error location, using a box.

The question learning support device 100 displays the error cause near the error occurrence area (S840). In operation S840, the question learning support device 100 may display the error cause detected by the artificial intelligence model 300 at the bottom of the error occurrence area.

The question learning support device 100 displays a solution formula symbol in the error occurrence area (S850). In operation S850, the question learning support device 100 may display a speech bubble-shaped solution formula symbol in the error occurrence area of the learner answer area on the learning question output screen.

When the learner selects the solution formula symbol (Yes in S860), the question learning support device 100 displays the correct solution formula (S870). In operation S870, the question learning support device 100 may overlap and output the display window that displays the correct solution formula on the learning question output screen when the learner selects the solution formula symbol.

Meanwhile, the question learning support method according to the embodiment of the present disclosure may include detecting whether the learner conducts an additional activity after displaying the result of the scoring (i.e., the error location, the error cause, etc.) in operation S800 and outputting a vibration alarm and/or a sound alarm in order to induce an additional activity such as incorrect answer correction when there is no additional activity of the learner or outputting an alarm in which text or a symbol/color blinks on the learning question output screen.

The above description is merely the exemplary description of the technical spirit of the present disclosure, and those skilled in the art to which the present disclosure pertains will be able to variously modify and change the present disclosure without departing from the essential characteristics of the present disclosure. Therefore, the embodiments disclosed in the present disclosure are not intended to limit the technical spirit of the present disclosure, but intended to describe the same, and the scope of the technical spirit of the present disclosure is not limited by these embodiments. The scope of the present disclosure should be construed by the appended claims, and all technical ideas within the equivalent scope should be construed as being included in the scope of the present disclosure.

1. A question learning support device comprising:
a control module configured to output a learning question output request message in response to a question learning start request, output a learner answer detection request message in response to a learning question output completion message, which is a response to the learning question output request message, output a learning question scoring request message in response to a learner answer detection completion message, which is a response to the learner answer detection request message, and output an evaluation output request message when it is determined that a learner's answer is incorrect based on a scoring completion message, which is a response to the learning question scoring request message;
a question information detection module configured to detect learning question information in response to the learning question output request message of the control module and output a question output request message including the learning question information;
a learning question output module configured to generate a learning question output screen including the learning question information in response to the question output request message of the question information detection module and transmit a learning question output completion message after outputting the learning question output screen;
a handwriting area detection module configured to detect a part of the learning question output screen as a learner answer area in response to a learner answer detection request message of the control module and output a handwriting area detection completion message including the learner answer area;
a handwriting recognition module configured to detect a learner's answer by performing handwriting recognition on the learner answer area in response to the handwriting area detection completion message of the handwriting area detection module and transmit a learner answer detection completion message including the learner's answer;
a scoring module configured to generate a scoring prompt including the learner's answer in response to the learning question scoring request message of the control module to transmit the scoring prompt to an artificial intelligence model and transmit a scoring completion message including a result of the scoring to the control module when receiving the result of the scoring, which is a response to the scoring prompt, from the artificial intelligence model; and
a scoring result output module configured to detect a part of the learner answer area as an error occurrence area based on the result of the scoring in response to the evaluation output request message of the control module and overlap and output the occurrence of an error in the error occurrence area.

2. The question learning support device of claim 1, wherein the learning question output module generates a learning question output screen including a learning question display area and a question solution area,
the learning question display area is an area, in which a learning question detected from the learning question information, of the learning question output screen, and
the question solution area is an area in which a question solution process of a learner to the learning question is input through handwriting.

3. The question learning support device of claim 1, wherein the handwriting area detection module detects an area, in which a solution process is handwritten, of a question solution area of the learning question output screen as the learner answer area.

4. The question learning support device of claim 1, wherein the handwriting area detection module detects the learner answer area, which includes vertex coordinates of an area in which a solution process is handwritten, of a question solution area of the learning question output screen.

5. The question learning support device of claim 1, wherein the handwriting recognition module detects a leaner's answer composed of text and detects a learner's answer composed of LaTex code when a learning question is a math question.

6. The question learning support device of claim 1, wherein the scoring module sets a prompt including a code area into which the learner's answer is inserted and generates a scoring prompt that inserts the learner's answer detected from the handwriting recognition module into the code area.

7. The question learning support device of claim 1, wherein the scoring module receives the result of the scoring including an error location and an error cause from the artificial intelligence model and transmits the scoring completion message including the result of the scoring to the control module.

8. The question learning support device of claim 1, wherein the control module determines that the learner's answer is incorrect when the result of the scoring detected from the scoring completion message includes an error location and transmits an evaluation output request message including the error location to the scoring result output module, and
the scoring result output module detects the error location from the evaluation output request message of the control module, detects an area, which corresponds to the error location, of the learner answer area of the learning question output screen as an error occurrence area and displays an error occurrence symbol in the error occurrence area.

9. The question learning support device of claim 1, wherein the control module determines that the learner's answer is incorrect when the result of the scoring detected from the scoring completion message includes an error location and an error cause and transmits an evaluation output request message including the error location and the error cause to the scoring result output module, and
the scoring result output module detects the error location and the error cause from the evaluation output request message of the control module, detects an area, which corresponds to the error location, of the learner answer area of the learning question output screen as an error occurrence area, displays an error occurrence symbol in the error occurrence area, and displays the error cause near the error occurrence area.

10. The question learning support device of claim 1,
wherein the control module determines that the learner's answer is correct when the result of the scoring detected from the scoring completion message does not include an error location and an error cause and transmits a positive feedback output request message to the scoring result output module, and
the scoring result output module overlaps and outputs positive feedback on the learning question output screen in response to the positive feedback output request message of the control module.

11. A question learning support method performed by a question learning support device, comprising:
detecting learning question information in response to a question learning start request;
outputting a learning question output screen including the learning question information detected in the detecting of the learning question information;
detecting a part of the learning question output screen as a learner answer area;
detecting a leaner's answer through handwriting recognition on a learner answer area detected in the detecting of the leaner answer area;
generating a scoring prompt including the learner's answer and outputting the scoring prompt to an artificial intelligence model; and
outputting a result of scoring of the artificial intelligence model, which is a response to the scoring prompt.

12. The question learning support method of claim 11, wherein the outputting of the learning question output screen includes outputting a learning question output screen including a learning question display area in which the learning question information is displayed and a question solution area in which a question solution process of a learner to the learning question is handwritten.

13. The question learning support method of claim 11, wherein the detecting of the learner's answer includes detecting an area, in which a solution process is handwritten, of a question solution area of the learning question output screen as the learner answer area.

14. The question learning support method of claim 11, wherein the detecting of the learner's answer includes detecting the learner answer area including vertex coordinates of an area, in which a solution process is handwritten, of a question solution area of the learning question output screen.

15. The question learning support method of claim 11, wherein the detecting of the learner's answer includes detecting a leaner's answer composed of text and detecting a learner's answer composed of LaTex code when a learning question is a math question.

16. The question learning support method of claim 11, wherein the outputting of the scoring prompt includes:
setting a prompt including a code area into which the learner's answer is inserted; and
outputting a scoring prompt that inserts the learner's answer detected in the detecting of the learning's answer into the code area.

17. The question learning support method of claim 11, wherein the outputting of the result of the scoring includes detecting a part of the learner answer area as an error occurrence area and overlapping and outputting occurrence of an error in the error occurrence area.

18. The question learning support method of claim 11, wherein the outputting of the result of the scoring includes:
determining that the learner's answer is correct when the result of the scoring of the artificial intelligence model does not include an error location and an error cause; and
overlapping and outputting positive feedback on the learning question output screen.

19. The question learning support method of claim 11, wherein the outputting of the result of the scoring includes:
determining that the learner's answer is incorrect when the result of the scoring received from the artificial intelligence model includes an error location;
detecting an area, which corresponds to the error location, of the learner answer area of the learning question output screen as an error occurrence area; and
displaying an error occurrence symbol in the error occurrence area.

20. The question learning support method of claim 11, wherein the outputting of the result of the scoring includes:
determining that the learner's answer is incorrect when the result of the scoring received from the artificial intelligence model includes an error location and an error cause;
detecting an area, which corresponds to the error location, of the learner answer area of the learning question output screen as an error occurrence area;
displaying an error occurrence symbol in the error occurrence area; and
displaying the error cause near the error occurrence area.
